(19) United States
(12) Patent Application Publication
(10) Pub. No.: US 2007/0146534 A1
(43) Pub. Date: Jun. 28, 2007

(54) Camera module package

(75) Inventors: Jung Jin Kim, Hwasung (KR); Jung Hoon Lee, Hwasung (KR); Kazuhiko Suenobu, Suwon (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/638,396

(22) Filed: Dec. 14, 2006

(30) Foreign Application Priority Data
Dec. 27, 2005 (KR) 10-2005-0130422

(51) Int. Cl. H04N 5/225

(52) U.S. Cl. 348/340

(57) ABSTRACT

The invention relates to a camera module package including a lens barrel having at least one lens therein and an IR filter installed at a lower end thereof. The package also includes a housing having the lens barrel disposed movable in an optical axis direction in an inner hole thereof. The package additionally includes a ceramic substrate attached to a lower end of the housing, the ceramic substrate having an opening formed on an upper surface thereof corresponding to the position of the lens. The package further includes an image sensor electrically connected to a lower part of the ceramic substrate, the image sensor having an image sensing region thereof exposed through the opening of the ceramic substrate. This prevents damaging the components by the adhesive leaking during the assembly, defective products due to infiltration of extraneous material, improves product reliability and reduces manufacturing costs.

This application claims the benefit of Korean Patent Application No. 2005-0130422 filed on Dec. 27, 2005, in the Korean Intellectual Property Office, the disclosure of which is incorporated herein by reference.

### BACKGROUND OF THE INVENTION

1. Field of the Invention

The present invention relates to a camera module package, and more particularly, to a camera module package which simplifies an assembly process with a fewer components therein, prevents infiltration of extraneous material to obviate defective images and obtain superior quality images, and achieves miniaturization with reduced volume.

2. Description of the Related Art

Currently, a number of mobile terminal manufacturers are developing and mass-producing mobile terminals with camera module packages. Such camera module packages mounted inside the mobile terminals are developed in various forms according to the components and packaging methods.

In general, a cameral module package can be classified mainly into Chip on Film (COF), Chip on Board (COBB), Chip Scale Package (CSP). And the current trend is to develop the camera module packages with focuses on high pixel, multi-function, miniaturization and low costs.

Among the above types, the COB using a wire-bonding method adopts a process similar to the existing production process of the semiconductor and thus has high productivity compared to other packaging methods. But since an image sensor and a substrate is electrically connected via the wires, the COB requires an additional space with a large overall package size and is limited in the number of circuits processed.

The flip-chip type COF does not require a separate space for connecting both ends of the wire to the image sensor and the substrate, thus reducing the area of the package to achieve miniaturization. Further, it can reduce the height of the barrel to miniaturize the package, uses a thin film or ductile PCB as the substrate to obtain a package reliable to external impacts, and involves a relatively simple process. In addition to the miniaturization of the package, signals can be processed quickly due to the smaller package size, less resistance, high density and multi-function.

In the meantime, the CSP, which is the most effective way to miniaturize the package, has limitations as an image sensor, such as costly and prolonged manufacturing processes.

FIG. 1 is a block diagram illustrating a conventional camera module package and FIG. 2 is a sectional view illustrating the conventional camera module package. As shown, the camera module package 1 includes a lens barrel 10, a housing 20, a Flexible Printed Circuit Board (FPCB) 30 and an image sensor 40.

The lens barrel 10 is a hollow cylinder having a lens (not shown) therein. The lens barrel 10 has male threads 11 formed on an outer surface thereof and a cap 13 assembled to an upper end thereof.

There may be at least one lens provided in the lens barrel 11, and the number of the lens may vary according to the function and capacity of the camera module package desired to be realized.

The housing 20 has an inner hole for receiving the lens barrel 10, and has female threads 21 formed on an inner circumferential surface to be engaged with the male threads 11 of the lens barrel 10. The housing 20 also has an IR filter 25 for filtering the light passed through the lens.

With the above configuration, the lens barrel 10 is assembled into the female threads 21 of the housing, disposed movable in an optical axis direction with respect to the housing 20 fixed in its position.

The FPCB 30 is bonded to a lower part of the housing 20, having an opening formed at an end thereof to expose an image forming region of the image sensor 40 where the image of an object passed through the lens is formed. The FPCB 30 also has at least one passive element 39 mounted on an upper surface thereof.

Further, the FPCB 30 has a connector 35 at the other end thereof to be connected to a corresponding connector (not shown) so as to be connected to a display means (not shown).

A liquid polymer adhesive 36 is applied along a rectangular frame on the FPCB 30, corresponding to the plurality of stud bumps 41 formed on an upper surface of the image sensor 40. Then, the image sensor 40 is flip-chip bonded to the FPCB 30 via hot pressing the image sensor 40 to a lower surface of the FPCB 30 in order to align the image forming region and the opening 34.

This allows conductive particles between the corresponding terminals of the FPCB 30 and the image sensor 40 to be connected to each other in a single direction of conductivity, thereby electrically and mechanically connecting the terminals.

However, as the FPCB 30 and the image sensor 40 are bonded by applying the liquid polymer adhesive and hot pressing, the manufacturing process is complicated and cumbersome.

In addition, in the case where extraneous material infiltrates the IR filter 25 of the housing 20 mounted on the FPCB 30 or in the image sensor 40, it is difficult to clean the image sensor 40 to eliminate the extraneous material, degrading the image quality of the camera module.

Moreover, a separate connector 35 is provided and assembled to the other end of the FPCB 30, increasing the number of components while limiting the volume reduction of the package.

### SUMMARY OF THE INVENTION

The present invention has been made to solve the foregoing problems of the prior art and therefore an object of certain embodiments of the present invention is to provide a camera module package which simplifies an assembly process with a fewer number of components therein, prevents infiltration of foreign material to obtain superior quality images, and achieves miniaturization with reduced volume.

According to an aspect of the invention for realizing the object, there is provided a camera module package including: a lens barrel having at least one lens therein and an IR filter installed at a lower end thereof; a housing having the lens barrel disposed movable in an optical axis direction in an inner hole thereof; a ceramic substrate attached to a lower end of the housing, the ceramic substrate having an opening formed on an upper surface thereof corresponding to the position of the lens; and an image sensor electrically connected to a lower part of the ceramic substrate, the image sensor having an image sensing region thereof exposed through the opening of the ceramic substrate.

Preferably, the ceramic substrate has a plurality of external connection terminals formed on an outer surface thereof.

Preferably, the ceramic substrate has at least one passive elements mounted on an upper surface thereof.

Preferably, the ceramic substrate has at least one passive element embedded in inner ceramic layers thereof.

Preferably, the ceramic substrate has fixing grooves at an outer periphery of an upper surface thereof for receiving protrusions protruded from a lower end of the housing.

Preferably, the ceramic substrate has a sensor receiving part formed on a lower surface thereof for receiving the image sensor, and the sensor receiving part has connection terminals corresponding to stud bumps formed on the image sensor.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a general camera module package;

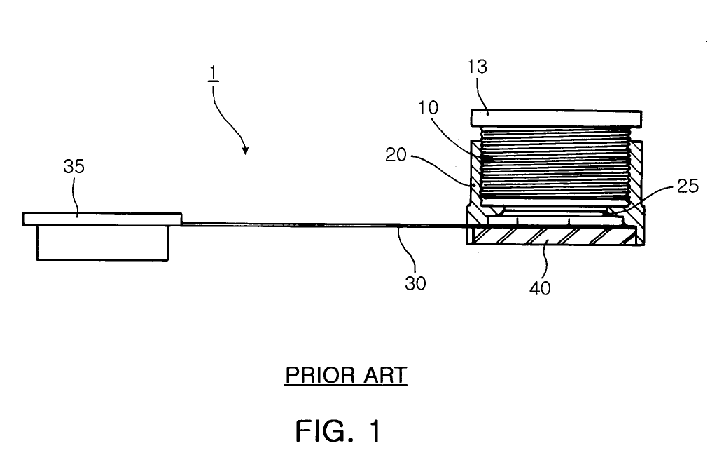

FIG. 2 is a sectional view illustrating the general camera module package;

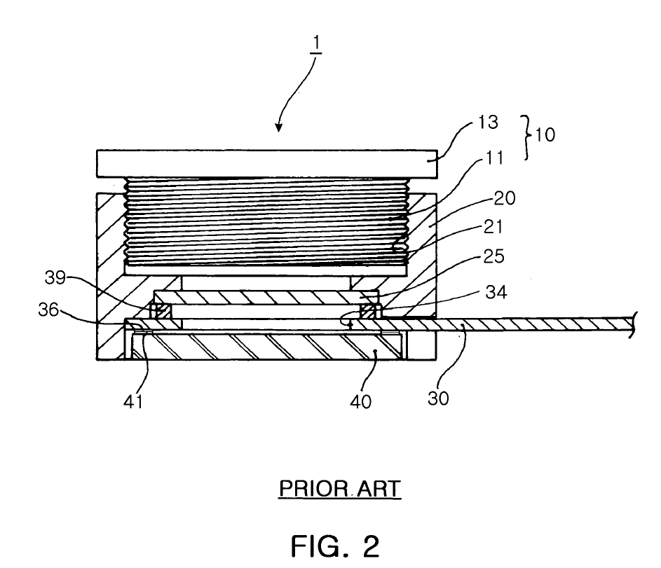

FIG. 3 is an exploded perspective view illustrating a camera module package according to the present invention; and

FIG. 4 is a sectional view illustrating the camera module package according to the present invention.

### DETAILED DESCRIPTION OF THE PREFERRED EMBODIMENT

Preferred embodiments of the present invention will now be described in detail with reference to the accompanying drawings.

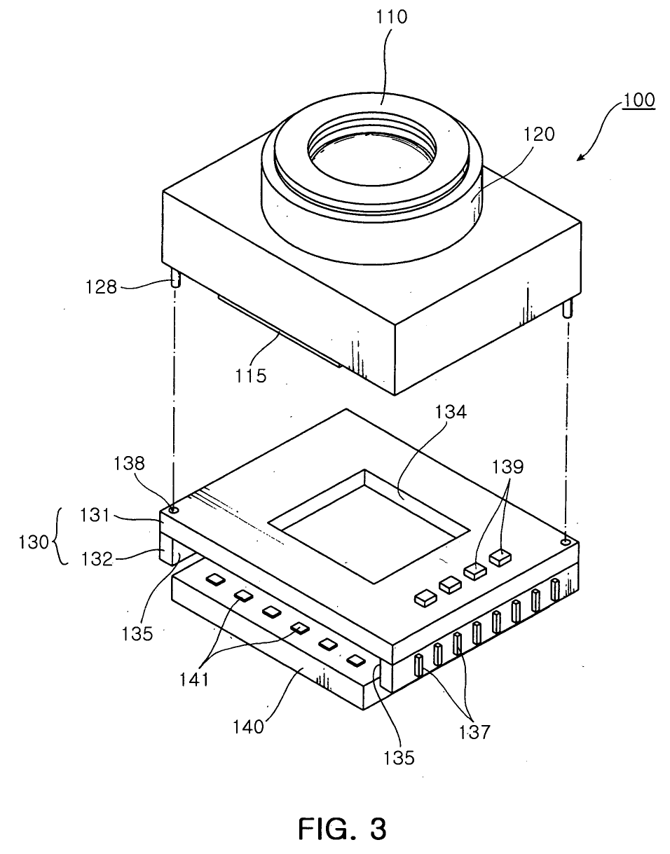

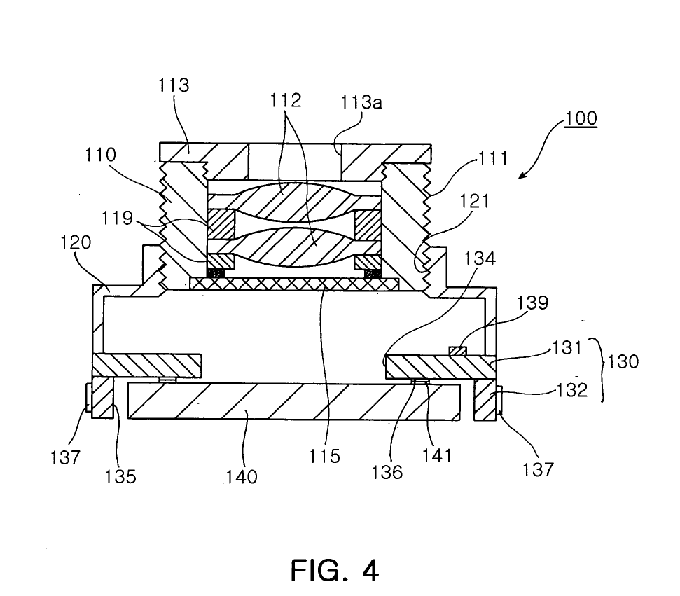

FIG. 3 is an exploded perspective view illustrating a camera module package according to the present invention, and FIG. 4 is a sectional view illustrating the camera module package according to the present invention.

As shown in FIGS. 3 and 4, the camera module package 100 includes a lens barrel 110, a housing 120, a substrate 130 and an image sensor 140.

The lens barrel 110 has a cylindrical shape and has a predetermined dimension of inner space where at least one lens 112 is disposed along an optical axis.

The plurality of lenses 112 disposed in the lens barrel 110 may be spaced apart from another lens in a predetermined interval by a spacer 119.

The lens barrel 110 has male threads 111 formed on an outer surface thereof and a cap 113 assembled atop. The cap 113 has a light incident hole 113 a perforated in a center thereof and serves to fix the lenses 112 received in the lens barrel 110 in a fixed position.

In addition, the lens barrel 110 has an IR filter 115 bonded by an adhesive to a lower end thereof for filtering the light passed through the lens barrel 110 with the lenses 112 therein.

Here, the IR filter 115 may be provided on a lower end of the lens barrel 110 but is not limited thereto. The IR filter may also be bonded by an adhesive to a step formed at a lower periphery of an inner hole or the inner space of the lens barrel 110 in which the lenses 112 are disposed.

In addition, the housing 120 has female threads formed on an inner circumferential surface of the inner hole thereof to be engaged with the male threads 111 of the lens barrel 110 so that the lens barrel 110 is received in the housing 120.

With the above configuration, the lens barrel 110 with the lenses 112 and the IR filter 115, is capable of moving along the optical axis with respect to the housing 120 fixed by the thread engagement of the male threads 111 and the female threads 121, and also the IR filter 115, along with the lens barrel 110, is detachable from the housing 120.

Meanwhile, the housing 120 has fixing protrusions 128 protruded from a lower surface thereof, corresponding to the fixing grooves 138 formed on the substrate 130 in order to facilitate the assembly of the housing 120 and the substrate 130 and align the center of the opening 134 of the substrate 130 with the optical axis of the lens barrel 110, thereby locating the housing on the substrate.

In addition, the ceramic substrate 130 has a lower end of the housing 120 with the lens barrel 110 assembled therein mounted on an upper surface thereof, and has the opening 134 formed on an upper surface thereof, corresponding to the lens 112 inside the lens barrel 110.

The ceramic substrate 130 has the fixing grooves 138 formed in an outer periphery of an upper surface thereof for receiving the fixing protrusions 128 protruded from a lower end of the housing 120.

The ceramic substrate 130 has a sensor receiving part 135 formed on a lower surface thereof for housing the image sensor 140, and the sensor receiving part 135 has connection terminals 136 corresponding to stud bumps 141 of the image sensor 140.

Here, it is preferable that the connection terminals 136 of the ceramic substrate 130 is made of tin or tin alloy-based plating material so as to be connected to the stud bumps of the image sensor 140 via hot pressing or ultrasonic bonding.

This allows omitting the conventional process of applying non-conductive liquid polymer adhesive 36 to a bonding region along a rectangular frame, corresponding to the stud bumps 141 of the image sensor 140 in order to bond the FPCB with the image sensor, simplifying the manufacturing process of the package.

In addition, at least one passive element such as a capacitor and a resistor can be provided on an upper surface of the ceramic substrate 130 composed of at least two ceramic sheets 131 and 1132 stacked so as to reduce electric noise. Also, the passive elements may be embedded between the ceramic sheets 131 and 132, in the form of an internal electrode pattern functioning as a resistor and capacitor.

In addition, the ceramic substrate 130 has a plurality of external connection terminals 137 on an outer surface thereof so as to be connected to a socket (not shown) of a main board electrically connected to a display means (not shown). Thus, there is no need to provide a separate connector 35 at the other end of the image sensor as in the prior art, simplifying the configuration of the substrate and reducing the total volume of the substrate 130.

Meanwhile, the image sensor 140 has an image forming region formed in a central portion of an upper surface thereof, exposed through the opening 134 of the ceramic substrate 130. The image sensor 140 is provided in the sensor receiving part 135 of the ceramic substrate 130, positioned to be connected to the connection terminals 136 of the ceramic substrate 130.

The stud bumps of the image sensor 140 corresponding to the connection terminals 136 is made of tin or gold-based plating material so as to be bonded and electrically connected to the connection terminals 136 with high adhesive strength via hot pressing or ultrasonic bonding.

Here, a filler may be filled between the outer periphery of the image sensor 140 and the inner surface of the sensor receiving part 135 to further increase the bonding strength between the image sensor 140 and the ceramic substrate 130.

In the above described manufacturing process of the camera module 100, the lens barrel 110 having at least one lens 112 therein and an IR filter 115 mounted at a lower end thereof and the housing 120 with the female threads 121 formed on an inner surface thereof corresponding to the male threads 111 of the lens barrel 110 are prepared respectively and threadly engaged with each other so as to allow movement in the optical axis direction.

Here, the IR filter 115 of transparent medium is bonded to a lower end of the lens barrel 110 by an adhesive, perpendicular to the optical axis of the lens barrel 110.

In addition, with the housing 120 assembled with the lens barrel 110 placed on an upper part of the ceramic substrate 130 composed of at least two layers of ceramic sheets 131 and 132 stacked, the fixing protrusions 128 protruded from a lower end of the housing 120 are assembled one-to-one with the fixing grooves 138 formed on an outer periphery of an upper surface of the ceramic substrate 130, thereby locating the housing on the ceramic substrate 130.

At the same time, the adhesive is applied between a lower end of the housing 120 and an upper surface of the ceramic substrate 130, thereby mounting the housing 120 perpendicular to the ceramic substrate 130.

Here, as the fixing grooves 138 are perforated in an uppermost ceramic sheet stacked on a lower ceramic sheet, the adhesive is prevented from permeating into the ceramic substrate while the housing 120 and the ceramic substrate 130 are bonded to each other.

Subsequently, the image sensor 140 is disposed in the sensor receiving part 135 of the ceramic substrate 130 with the housing 120 mounted thereon, and the stud bumps 141 of the image sensor 140 are connected to the connection terminals 136 of the sensor receiving part 135.

At this time, a predetermined pressing force is applied to a contact surface between the connection terminals 136 and the stud bumps 141 with a source of heat provided, thereby bonding the two via hot pressing or ultrasonic bonding by applying ultrasonic waves.

Here, the image forming region of the image sensor 140 is exposed through the opening 134 formed through the ceramic substrate 130, in alignment with the optical axis of the lens barrel 110.

Here, the opening 134 and the sensor receiving part 135 of the ceramic substrate 130 are formed by stacking a plurality of ceramic sheets in a rectangular frame shape. It is preferable that the sensor receiving part 135 is formed in such a depth that the bottom of the image sensor 130 disposed in the sensor receiving part 135 is not protruded more than the lower edge of the ceramic substrate 130.

In the meantime, as the ceramic substrate 130 with the housing 120 and the image sensor 140 is inserted into a socket (not shown) of a main board electrically connected to a display means by pressing down directly, the external connection terminals 137 formed on an outer surface of the ceramic substrate 130 are easily assembled and electrically connected with the terminals parts of the socket.

In addition, in the case where extraneous material infiltrates the upper surface, i.e., the image forming region of the image sensor 140, the lens barrel 110 with the IR filter 115 can be separated from the housing 120, exposing the image sensor 140 through the opening of the housing 120. This allows cleaning the image sensor 140 to easily remove the extraneous material.

According to the present invention set forth above, the housing threadly engaged with the lens barrel including the IR filter attached at a lower end thereof is mounted on the ceramic substrate, and the image sensor is provided on a lower part of the ceramic substrate with its image forming region exposed. This allows directly bonding the terminals via hot pressing and ultrasonic bonding without applying a liquid polymer adhesive between the substrate and the image sensor as in the prior art, thereby simplifying the manufacturing process and improving productivity.

In addition, the lens barrel with the IR filter is detached from the housing to easily eliminate extraneous material infiltrating the image forming region of the image sensor, thereby preventing defective images and obtaining superior quality images.

Further, the external connection terminals provided at an outer surface of the ceramic substrate is directly connected to the socket of the main board, without requiring components such as the connector in the prior art, thereby reducing the manufacturing costs and volume of the package.

While the present invention has been shown and described in connection with the preferred embodiments, it will be apparent to those skilled in the art that modifications and variations can be made without departing from the spirit and scope of the invention as defined by the appended claims.

What is claimed is:

1. A camera module package comprising:
a lens barrel having at least one lens therein and an IR filter installed at a lower end thereof;
a housing having the lens barrel disposed movable in an optical axis direction in an inner hole thereof;
a ceramic substrate attached to a lower end of the housing, the ceramic substrate having an opening formed on an upper surface thereof corresponding to the position of the lens; and
an image sensor electrically connected to a lower part of the ceramic substrate, the image sensor having an image sensing region thereof exposed through the opening of the ceramic substrate.

2. The camera module package according to claim 1, wherein the ceramic substrate has a plurality of external connection terminals formed on an outer surface thereof.

3. The camera module package according to claim 1, wherein the ceramic substrate has at least one passive elements mounted on an upper surface thereof.

4. The camera module package according to claim 1, wherein the ceramic substrate has at least one passive element embedded in inner ceramic layers thereof.

5. The camera module package according to claim 1, wherein the ceramic substrate has fixing grooves at an outer periphery of an upper surface thereof for receiving protrusions protruded from a lower end of the housing.

6. The camera module package according to claim 1, wherein the ceramic substrate has a sensor receiving part formed on a lower surface thereof for receiving the image sensor, and the sensor receiving part has connection terminals corresponding to stud bumps formed on the image sensor.
